(19) United States
(12) Patent Application Publication
(10) Pub. No.: US 2023/0019527 A1
(43) Pub. Date: Jan. 19, 2023

(54) VIRTUAL ROLE CONTROL METHOD AND APPARATUS, STORAGE MEDIUM, AND COMPUTER DEVICE

(71) Applicant: Tencent Technology (Shenzhen) Company Limited, Shenzhen (CN)

(72) Inventors: Yutong XU, Shenzhen (CN); Zhihong LIU, Shenzhen (CN)

(21) Appl. No.: 17/956,693

(22) Filed: Sep. 29, 2022

Related U.S. Application Data
(63) Continuation of application No. PCT/CN2021/102825, filed on Jun. 28, 2021.

(30) Foreign Application Priority Data
Aug. 12, 2020 (CN) 202010809371.X

(51) Int. Cl. A63F 13/58; A63F 13/35; A63F 13/52

(52) U.S. Cl. CPC A63F 13/58; A63F 13/35; A63F 13/52

(57) ABSTRACT

This application discloses a virtual role control method performed by a computer device. The method includes: displaying, on a display interface, a virtual scene corresponding to a virtual task, the virtual scene comprising at least one virtual role belonging to a first camp and at least one virtual role belonging to a second camp; when a first target virtual role in the first camp is killed by a virtual role of the second camp, switching the first target virtual role from the first camp to the second camp; when all the virtual roles of the first camp are killed in the virtual scene, displaying that the second camp wins on the display interface; and when a duration for executing the virtual task reaches a predetermined duration and at least one virtual role of the first camp still exists in the virtual scene, displaying that the first camp wins on the display interface.

### CROSS-REFERENCE TO RELATED APPLICATIONS

This application is a continuation application of PCT Patent Application No. PCT/CN2021/102825, entitled “VIRTUAL CHARACTER CONTROL METHOD AND APPARATUS, STORAGE MEDIUM AND COMPUTER DEVICE” filed on Jun. 28, 2021, which claims priority to Chinese Patent Application No. 202010809371.X, filed with the State Intellectual Property Office of the People's Republic of China on Aug. 12, 2020, and entitled “VIRTUAL CHARACTER CONTROL METHOD AND DEVICE, STORAGE MEDIUM AND ELECTRONIC DEVICE”, all of which are incorporated herein by reference in their entirety.

### FIELD OF THE TECHNOLOGY

This application relates to the computer field, and in particular, to a virtual role control method and apparatus, a computer readable storage medium, and a computer device.

### BACKGROUND OF THE DISCLOSURE

In a virtual scene (such as a game), there is a mode in which a system evenly divides a plurality of virtual roles into two camps. Virtual roles of the two camps compete with each other, and finally, the virtual roles of one camp win according to a winning or losing condition.

However, in a related technology, the foregoing camp allocation method is fixed, and each virtual role is fixed in a camp in the virtual scene. In a process in which a user performs a virtual scene operation for the virtual scene, a camp to which a controlled virtual role belongs cannot be adjusted unless the virtual scene operation for the virtual scene ends, and the user enters again to select a camp or wait for random allocation, which causes low efficiency of adjusting the camp of the virtual role.

### SUMMARY

Embodiments of this application provide a virtual role control method and apparatus, a computer readable storage medium, and a computer device, which can improve adjustment efficiency of a camp to which a virtual role belongs in a virtual scene.

An embodiment of this application provides a virtual role control method, applied to a computer device, where the method includes:

displaying, on a display interface, a virtual scene corresponding to a virtual task, the virtual scene comprising at least one virtual role belonging to a first camp and at least one virtual role belonging to a second camp;

when a first target virtual role in the first camp is killed by a virtual role of the second camp, switching the first target virtual role from the first camp to the second camp;

when all the virtual roles of the first camp are killed in the virtual scene, displaying that the second camp wins on the display interface;

when all the virtual roles of the first camp are killed in the virtual scene, displaying that the second camp wins on the display interface; and

when a duration for executing the virtual task reaches a predetermined duration and at least one virtual role of the first camp still exists in the virtual scene, displaying that the first camp wins on the display interface.

An embodiment of this application further provides a virtual role control apparatus, including:

a first display unit, configured to display, on a display interface, a virtual scene corresponding to a virtual task, the virtual scene comprising at least one virtual role belonging to a first camp and at least one virtual role belonging to a second camp;

a first changing unit, configured to: when a first target virtual role in the first camp is killed by a virtual role of the second camp, switch the first target virtual role from the first camp to the second camp;

a second changing unit, configured to: when all the virtual roles of the first camp are killed in the virtual scene, display that the second camp wins on the display interface;

a second display unit, configured to, when all the virtual roles of the first camp are killed in the virtual scene, display that the second camp wins on the display interface; and

a third display unit, configured to, when a duration for executing the virtual task reaches a predetermined duration and at least one virtual role of the first camp still exists in the virtual scene, display that the first camp wins on the display interface.

An embodiment of this application provides a computer program product or a computer program. The computer program product or the computer program includes computer instructions, and the computer instructions are stored in a non-transitory computer-readable storage medium. A processor of a computer device reads the computer instructions from the computer readable storage medium, and the processor executes the computer instructions, so that the computer device performs the foregoing virtual role control method.

An embodiment of this application further provides a non-transitory computer readable storage medium that stores executable instructions, and when the executable instructions are executed by a processor, the foregoing virtual role control method provided in the embodiment of this application is implemented.

An embodiment of this application further provides a computer device, including a memory and a processor;

the memory being configured to store executable instructions; and

the processor being configured to: when running the executable instructions stored in the memory, implement the foregoing virtual role control method provided in the embodiment of this application.

In the embodiments of this application, the method includes: displaying, on a display interface, a virtual scene corresponding to a virtual task, the virtual scene comprising at least one virtual role belonging to a first camp and at least one virtual role belonging to a second camp; when a first target virtual role in the first camp is killed by a virtual role of the second camp, switching the first target virtual role from the first camp to the second camp; when all the virtual roles of the first camp are killed in the virtual scene, displaying that the second camp wins on the display interface; and when a duration for executing the virtual task reaches a predetermined duration and at least one virtual role of the first camp still exists in the virtual scene, displaying that the first camp wins on the display interface. In this way, in the process of executing the virtual task in the virtual scene, the camp of the virtual role can be automatically adjusted according to interaction between virtual roles in different camps, and the current virtual task does not need to end to re-enter the virtual scene to adjust the camp of the virtual role, thereby improving adjustment efficiency of the camp to which the virtual role belongs in the virtual scene, and improving human-computer interaction efficiency while improving utilization of a hardware resource.

### BRIEF DESCRIPTION OF THE DRAWINGS

FIG. 1 is a schematic diagram of an application environment of a virtual role control method according to an embodiment of this application.

FIG. 2 is a schematic diagram of an application environment of a virtual role control method according to an embodiment of this application.

FIG. 3 is a schematic diagram of an application environment of a virtual role control method according to an embodiment of this application.

FIG. 4 is a schematic flowchart of a virtual role control method according to an embodiment of this application.

FIG. 5 is a schematic diagram of a client display interface of a virtual role control method according to an embodiment of this application.

FIG. 6 is a schematic diagram of mode selection of a virtual role control method according to an embodiment of this application.

FIG. 7 is a schematic diagram of a special mode details interface of a virtual role control method according to an embodiment of this application.

FIG. 8 is a schematic diagram of countdown of a virtual role control method according to an embodiment of this application.

FIG. 9 is a schematic diagram of a prompt indicating undead appearance of a virtual role control method according to an embodiment of this application.

FIG. 10 is a schematic diagram of a client display interface of the undead of a virtual role control method according to an embodiment of this application.

FIG. 11 is a schematic diagram of a client display interface of a human role of a virtual role control method according to an embodiment of this application.

FIG. 12 is a schematic diagram of a fearless hero of a virtual role control method according to an embodiment of this application.

FIG. 13 is a schematic diagram of human victory of a virtual role control method according to an embodiment of this application.

FIG. 14 is a schematic flowchart of a virtual role control method according to an embodiment of this application.

FIG. 15 is a schematic diagram of interaction between a player A's client and a server in a virtual role control method according to an embodiment of this application.

FIG. 16 is a schematic diagram of signal smoke hit point of a virtual role control method according to an embodiment of this application.

FIG. 17 is a schematic diagram of signal smoke re-throwing of a virtual role control method according to an embodiment of this application.

FIG. 18 is a schematic diagram of randomly placing a first prop in a virtual scene of a virtual role control method according to an embodiment of this application.

FIG. 19 is a schematic structural diagram of a virtual role control apparatus according to an embodiment of this application.

FIG. 20 is a schematic structural diagram of a computer device according to an embodiment of the present disclosure.

### DESCRIPTION OF EMBODIMENTS

To enable a person skilled in the art to understand the solutions in this application more clearly, the following clearly and fully describes the technical solutions in the embodiments of this application with reference to the drawings hereof. Apparently, the described embodiments are merely a part of but not all of the embodiments of this application. All other embodiments derived by a person of ordinary skill in the art based on the embodiments of the present disclosure without making any creative effort fall within the protection scope of the present disclosure.

The terms such as “first” and “second” in the specification, claims, and drawings of this application are intended to distinguish between similar items, but not to indicate a specific order or sequence. It is to be understood that the data termed in such a way is interchangeable in proper circumstances, so that the embodiments of this application described herein can be implemented in other sequences than the sequence illustrated or described herein. Moreover, the terms “include”, “contain” and any other variants mean to cover the non-exclusive inclusion. For example, a process, method, system, product, or device that includes a list of steps or units is not necessarily limited to those steps or units, but may include other steps or units not expressly listed or inherent to such a process, method, product, or device.

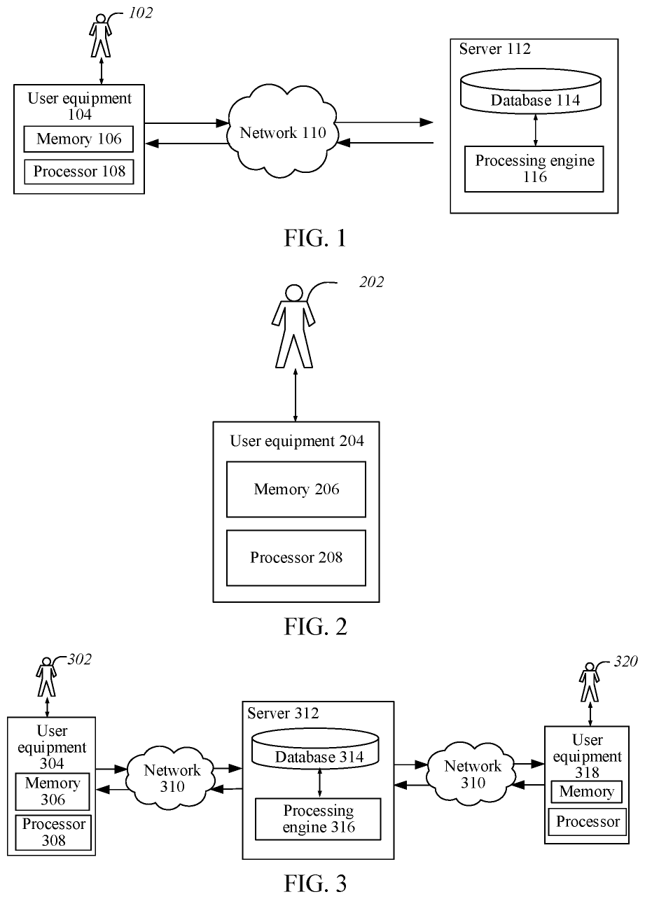

An embodiment of this application provides a virtual role control method. In an implementation, the virtual role control method may be applied to the environment shown in FIG. 1, but is not limited thereto.

In FIG. 1, a user 102 may perform human-computer interaction with user equipment 104. The user equipment 104 includes a memory 106 configured to store interaction data and a processor 108 configured to process interaction data. The user equipment 104 and a server 112 may exchange data with each other via a network 110. The server 112 includes a database 114 configured to store interaction data and a processing engine 116 configured to process interaction data.

The user equipment 104 in this embodiment of this application may display a virtual scene corresponding to a virtual task. The user 102 may control a virtual role of a first camp or a virtual role of a second camp in the virtual scene. The virtual scene includes a plurality of virtual roles. The server 112 may control a first target virtual role to be changed from the first camp to the second camp, or control a second target virtual role to be changed from the second camp to the first camp. The user equipment 104 may display a camp change process of a role.

In another example, the foregoing virtual role control method in this embodiment of this application may be applied to FIG. 2. In FIG. 2, a user 202 may perform human-computer interaction with user equipment 204. The user equipment 204 includes a memory 206 configured to store interaction data and a processor 208 configured to process interaction data. The user equipment 204 may display a virtual role of a first camp and a virtual role of a second camp in a virtual scene corresponding to a virtual task, where the virtual scene includes a plurality of virtual roles, and may display a camp change process of the role.

In another example, the foregoing virtual role control method in this embodiment of this application may be applied to FIG. 3. In FIG. 3, a user 302 may perform human-computer interaction with user equipment 304. The user equipment 304 includes a memory 306 configured to store interaction data and a processor 308 configured to process interaction data. The user equipment 304 and a server 312 may exchange data with each other via a network 310. The server 312 includes a database 314 configured to store interaction data and a processing engine 316 configured to process interaction data. The server 312 may interact with a user equipment 318 by using the network 310, and the user equipment 318 may interact with a user equipment 320.

The user equipment 304 or the user equipment 320 may display a virtual scene. The virtual scene includes a virtual role of a first camp and a virtual role of a second camp. The user equipment 304 or the user equipment 320 may display a camp change process of the role.

In some embodiments, the user equipment 104, the user equipment 204, the user equipment 304, and the user equipment 320 may be but are not limited to terminals such as a smartphone, a tablet computer, a notebook computer, a PC, a smart speaker, a smart TV, and a smart watch. The network 110 may include but is not limited to a wireless network or a wired network. The wireless network includes: Wi-Fi, and another network implementing wireless communication. The wired network may include, but is not limited to: a wide area network, a metropolitan area network, and a local area network.

In actual applications, the server 112 and the server 312 may be independent physical servers, may also be server clusters or distributed systems composed of a plurality of physical servers, and may also be cloud servers providing basic cloud computing services, such as a cloud service, a cloud database, cloud computing, a cloud function, cloud storage, a network service, cloud communication, a middleware service, a domain name service, a security service, a CDN, and a big data and AI platform.

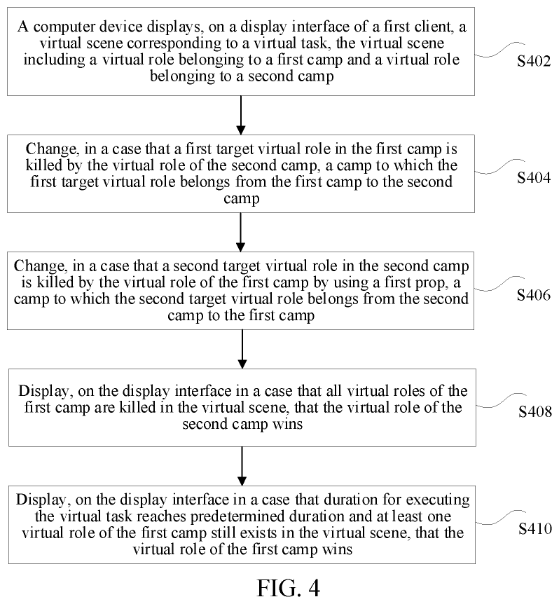

In some embodiments, as shown in FIG. 4, the foregoing virtual role control method includes the following steps:

S402. A computer device displays, on a display interface of a first client, a virtual scene corresponding to a virtual task, the virtual scene including at least one virtual role belonging to a first camp and at least one virtual role belonging to a second camp.

In actual implementation, the second camp may be an opposite camp of the first camp.

S404. Change, when a first target virtual role in the first camp is killed by the virtual role of the second camp, a camp to which the first target virtual role belongs from the first camp to the second camp. In some embodiments, the first target virtual role also changes its visual appearance when it switches from the first camp to the second camp. For example, the virtual roles in the second camp may have the same visual appearance unique to the second camp while different virtual roles in the first camp have different visual appearance from each other. In this case, the first target virtual role, after being switched to the second camp, will have the same appearance as the other virtual roles in the second camp. In some embodiments, the virtual role of the first camp and the virtual role of the second camp have different visual appearances.

S406. Change, when a second target virtual role in the second camp is killed by the virtual role of the first camp by using a first prop, a camp to which the second target virtual role belongs from the second camp to the first camp. In some embodiments, when a virtual role of the second camp is killed by a virtual role of the first camp, the virtual role of the second camp is respawned at a first location of the virtual scene. The first location is a location randomly selected before the virtual role of the second camp is respawned. When the virtual role of the second camp marks a second location, the second location is determined as the first location associated with the virtual role of the second camp. When the virtual role of the second camp marks a third location, the first location associated with the second target virtual role is changed from the second location to the third location. When a virtual role of the first camp de-marks a first location, the first location associated with the second target virtual role is set to a randomly-selected location. When a second target virtual role in the second camp is affected by a virtual role of the first camp by using a first prop, the second target virtual role is switched from the second camp to the first camp.

S408. Display, on the display interface when all virtual roles of the first camp are killed in the virtual scene, that the virtual role of the second camp wins.

S410. Display, on the display interface when duration for executing the virtual task reaches predetermined duration and at least one virtual role of the first camp still exists in the virtual scene, that the virtual role of the first camp wins.

In some embodiments, the foregoing virtual role control method may be applied to the game field, but is not limited thereto. A game may be but is not limited to a single-player game or a multi-player game. The single-player game may include a plurality of virtual roles, and all other roles except a first virtual role controlled by a first client are computer-controlled virtual roles. If the game is a multi-player game, each client of a plurality of clients may separately control one virtual role, and play the game in one virtual scene by using a server. The plurality of clients may display content in the virtual scene by using a display interface.

The virtual scene in this embodiment of this application may be a virtual scene of a virtual game constructed by the client or the server. The virtual scene may include a plurality of virtual roles. The first client displays the virtual scene by using the display interface, and the plurality of roles in the virtual scene may belong to different camps. For example, the virtual role belonging to the first camp and the virtual role belonging to the second camp are included. The virtual role of the first camp and the virtual role of the second camp are mutually hostile roles, and when the first target virtual role in the first camp is killed by the virtual role of the second camp, the camp to which the first target virtual role belongs is changed from the first camp to the second camp; and when the second target virtual role in the second camp is killed by the virtual role of the first camp by using the first prop, the camp to which the second target virtual role belongs is changed from the second camp to the first camp. In some embodiments, the first prop is provided to a virtual role of the first camp when a quantity of virtual roles in the second camp killed by the virtual role of the first camp is greater than a first threshold. In some embodiments, when combat information associated with a virtual role of the first camp meets a predetermined condition, the virtual role of the first camp is configured with a strengthened combat ability. For example, when the quantity of virtual roles in the second camp killed by the virtual role of the first camp reaches a second threshold, new equipment or skill is provided to the virtual roles of the first camp, or equipment or skill of the virtual roles of the first camp gets upgraded or combat parameters of the virtual roles of the first camp are increased. Alternatively, when a virtual role of the first camp is the only one virtual role of the first camp, the new equipment or skill is provided to the virtual roles of the first camp, or equipment or skill of the virtual roles of the first camp gets upgraded or combat parameters of the virtual roles of the first camp are increased.

In this embodiment of this application, in the process of executing the virtual task in the virtual scene, the camp of the virtual role can be automatically adjusted according to interaction between virtual roles in different camps, and the current virtual task does not need to end to re-enter the virtual scene to adjust the camp of the virtual role, thereby improving adjustment efficiency of the camp to which the virtual role belongs in the virtual scene, and improving human-computer interaction efficiency while improving utilization of a hardware resource.

In some embodiments, when the virtual scene is created, a plurality of roles in the virtual scene may be divided into virtual roles of the first camp and virtual roles of the second camp.

Alternatively, when the virtual scene is created, all roles in the virtual scene are virtual roles of the first camp, and within a period of time after the virtual scene is created, one or more roles in the camp are determined as virtual roles of the second camp.

In some embodiments, when the camp of the virtual role is changed, a display model of the virtual role may also be changed. Changes to the display model allow to intuitively see changes in the camp of the virtual role. In addition, a prompt may be performed on the display interface of the client, or a prompt may be performed via voice, so as to prompt a change to the camp of the virtual role.

In some embodiments, a third prop may be configured for the virtual role of the first camp, and the third prop may be a weapon, an armament, a consumable, or the like that can be used. The third prop may be a prop configured by the user before the virtual role of the first camp enters the virtual scene of the virtual game, or a prop allocated by the virtual scene after the virtual scene of the virtual game is entered. The virtual role of the first camp may attack the virtual role of the second camp by using the third prop. The virtual role of the second camp may be initially configured with a fourth prop to attack the virtual role of the first camp. Alternatively, the virtual role of the second camp may be configured with a third prop that is the same as that of the virtual role of the first camp. The virtual role of the second camp may attack the virtual role of the first camp by using the third prop/the fourth prop.

In this embodiment of this application, the virtual role of the first camp may pick up the first prop in the virtual scene, or configure the first prop for the virtual role of the first camp if a condition is met. After killing the virtual role of the second camp, the first prop may change the camp of the virtual role of the second camp to the first camp. The first prop may be placed in the virtual scene when a running time of the virtual task meets a requirement. If the virtual role of the first camp picks up the first prop, the first prop may be configured in a backpack of the virtual role of the first camp. The virtual role of the first camp may switch to and use the first prop. Alternatively, if a quantity of virtual roles in the second camp killed by the virtual role of the first camp reaches a first threshold, the first prop is configured into the backpack for the virtual role of the first camp.

In this embodiment of this application, when the virtual role of the second camp attacks the virtual role of the first camp by using the fourth prop, a hit point value of the virtual role of the first camp decreases. If the hit point value of the virtual role of the first camp is zeroed, the camp of the virtual role of the first camp whose hit point value is zeroed is changed to the second camp. In this case, a prop of the virtual role of the second camp may be upgraded, and a second prop may be configured for the virtual role of the second camp. The virtual role of the second camp may set a resurrection location by using the second prop. In addition, a more powerful attack prop may be configured for the virtual role of the second camp. If the virtual role of the second camp attacks the virtual role of the first camp by using the attack prop, the camp of the virtual role of the first camp that is hit is adjusted to the second camp as long as it is hit.

That is, the virtual role of the second camp in this embodiment of this application may upgrade the weapon by attacking or killing the virtual role of the first camp, and attack power of the weapon may be increasingly strong. In this application, the virtual role of the second camp may further evolve by killing the virtual role of the first camp, so as to acquire a higher hit point, a faster moving speed, an increased skill, and the like.

The second prop of the virtual role of the second camp may be thrown or placed in the virtual scene. After the second prop is thrown, a first location of the second prop is recorded. If a first hit point of the virtual role of the second camp reaches zero, the virtual role may be resurrected, and the resurrection location is in the first location.

Certainly, after being thrown or placed in the virtual scene, the second prop may be removed or attacked by the virtual role of the first camp. If the virtual role of the first camp removes the second prop placed by the virtual role of the second camp at the first location in the virtual scene, or attacks the second prop and destroys the second prop, the virtual role of the second camp that throws the second prop is resurrected at a random location in the virtual scene after the first hit point is zeroed, and cannot be resurrected at the first location.

In addition, after the second prop of the virtual role of the second camp is thrown to the first location, if the virtual role of the second camp picks up the second prop and throws it to a second location in the virtual scene, the virtual role of the second camp is resurrected at the second location after the first hit point is zeroed.

The virtual role of the first camp in this embodiment of this application may activate a more powerful weapon or improve a capability by killing the virtual role of the second camp, for example, increase an attack force.

A plurality of prop selections may be added to the virtual roles of the first camp. The props are initially in an un-selectable first state. After the virtual role of the first camp kills the virtual role of the second camp, powerful props may be gradually unlocked according to the quantity of killed virtual roles of the second camp, and the powerful props are adjusted from the first state to a second state. The powerful props that are adjusted to the second state may be selected and used by the virtual role of the first camp. The powerful props may have a stronger attack force or a faster shooting speed or a larger magazine size or higher accuracy.

In this embodiment of this application, if the quantity of virtual roles of the second camp killed by the virtual role of the first camp reaches a third threshold, or a quantity of remaining virtual roles of the first camp is less than a fourth threshold, a prop of the virtual role of the first camp may be changed from a current prop to a more powerful prop.

In this embodiment of this application, if the virtual task runs for a period of time, and the first camp still includes a virtual role that is not changed to the second camp, a level of the prop of the virtual role of the first camp is upgraded. The higher the level, the stronger the attribute may be, for example, the faster the shooting speed, the more the bullet capacity, the higher the power.

In another example, when the quantity of virtual roles of the second camp killed by the virtual role of the first camp reaches a third threshold, or a quantity of remaining virtual roles of the first camp is less than a fourth threshold, the virtual role of the first camp may be changed to a fighter virtual role with a stronger attribute. For example, the fighter virtual role is no longer attacked or does not change its camp after being killed, and the virtual role of the second camp that is killed by the fighter virtual role will not be resurrected. The fighter virtual role may have a hit point. When the virtual role of the second camp attacks the fighter virtual role, the hit point of the fighter virtual role decreases. If the hit point of the fighter virtual role falls to zero, the fighter virtual role dies, does not change to the virtual role of the second camp, and does not resurrect.

In this embodiment of this application, in a process in which the virtual role of the first camp and the virtual role of the second camp attack each other or compete with each other, a winning or losing condition may be set. For example, the winning or losing condition may be the quantity of kills. If a total quantity of virtual roles killed by a virtual role of a camp is higher, the virtual role of the camp wins. Alternatively, all virtual roles in the virtual scene of the virtual game change to virtual roles of the second camp, or duration of the virtual game ends may be used as the winning or losing condition. For example, when all the virtual roles in the virtual scene are virtual roles of the second camp, the virtual task ends, and it is prompted that all the virtual roles of the second camp win. Alternatively, if the game is performed for three minutes, and all the virtual roles in the three minutes become virtual roles of the second camp, the virtual roles of the second camp win. If there is still the virtual role of the first camp when three minutes ends, the remaining virtual role of the first camp wins, and the virtual role of the second camp loses.

In this embodiment of this application, the virtual role of the second camp may be changed to the virtual role of the first camp by using a predetermined prop. After the virtual role of the second camp is changed to the virtual role of the first camp, the prop is restored to the first prop. The predetermined prop may be a prop randomly generated in the virtual scene, and may be delivered at an interval of predetermined duration.

In this embodiment of this application, after the virtual role of the second camp attacks the virtual role of the first camp or kills the virtual role of the first camp, the virtual role of the first camp is changed to the virtual role of the second camp, and the camp of the virtual role of the second camp is changed to the first camp, thereby ensuring a virtual role balance of the two camps.

In some embodiments, after the virtual role of the first camp uses the first prop to kill the virtual role of the second camp, and when the camp of the virtual role of the second camp is changed to the first camp, determining may be further performed. If an initial camp of a killed virtual role is the first camp, and the camp of the virtual role is changed to the second camp after the virtual role is killed, the camp of the virtual role of the second camp may be re-adjusted to the first camp. If the initial camp of the virtual role of the second camp is the second camp, the camp of the virtual role of the second camp is no longer adjusted to the first camp.

According to this embodiment, in the process of executing the virtual task in the virtual scene, the camp of the virtual role can be automatically adjusted according to interaction between virtual roles in different camps, and the current virtual task does not need to end to re-enter the virtual scene to adjust the camp of the virtual role, thereby improving adjustment efficiency of the camp to which the virtual role belongs in the virtual scene, and improving human-computer interaction efficiency while improving utilization of a hardware resource.

In another example, in a process in which the virtual role of the first camp fights against the virtual role of the second camp, the method further includes:

when the virtual role of the first camp succeeds in killing the virtual role of the second camp, changing a prop configured for the virtual role of the first camp from a first type prop to a second type prop, where the first type prop is a prop used by the virtual role of the first camp, and the second type prop is a prop used by the virtual role of the second camp.

That is, after the camp of the virtual role of the first camp in this embodiment of this application changes, the prop remains a prop of the original camp. Only when the virtual role of the first camp is killed, the prop is configured as a prop used by the second camp after the change. By using this embodiment, fairness of props of virtual roles is ensured.

In some embodiments, the virtual scene may include at least two camps. Each two camps are opposed to each other. In the virtual scene, after a virtual role of any camp kills a virtual role of another camp, a camp of the killed virtual role may be adjusted to the camp of the killer. After the virtual task ends, winning or losing may be determined according to a total quantity of kills by each camp, or winning or losing may be determined according to a quantity of remaining virtual roles in each camp.

If there are only two camps in the virtual scene, winning or losing may be determined according to camp identifiers of all virtual roles at the end of execution of the virtual task. When it is determined, according to camp attribute identifiers, that all the virtual roles are virtual roles in a camp in which the target virtual role is located, it is determined that the winner of the virtual task is the camp in which the target virtual role is located. When it is determined, according to the camp attribute identifiers, that at least one virtual role in the virtual roles is not a virtual role in the camp in which the target virtual role is located, it is determined that the winner of the virtual task is a camp opposite to the camp in which the target virtual role is located.

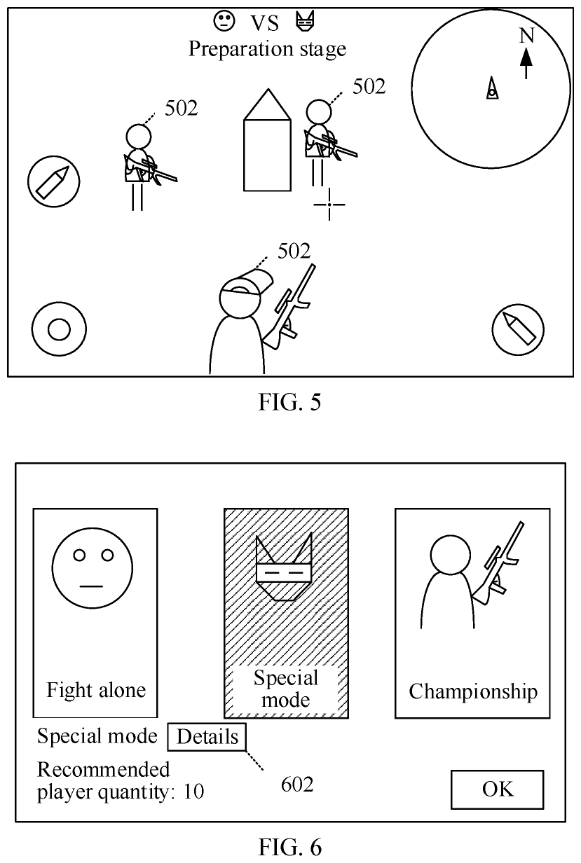

The following describes this embodiment of this application with reference to a specific example. This embodiment of this application may be applied to a multi-player game. A plurality of users separately log in to the game by using their respective clients, and connect to the same virtual game by using a server. The server runs a virtual scene, and each client may display the virtual scene and each object in the virtual scene by using a display interface of the client. For example, FIG. 5 may be a display interface of a first client used by one of the plurality of users. A virtual scene is displayed on the display interface, and the virtual scene includes a plurality of virtual roles 502. Each of the plurality of virtual roles may be a virtual role controlled by another user by using a client.

In this application, when the virtual scene is created, the plurality of virtual roles may be divided into virtual roles of a first camp and virtual roles of a second camp. Alternatively, in this application, when the virtual scene is created, the plurality of virtual roles may be determined as virtual roles of a first camp. The first camp may be a human camp or a monster camp.

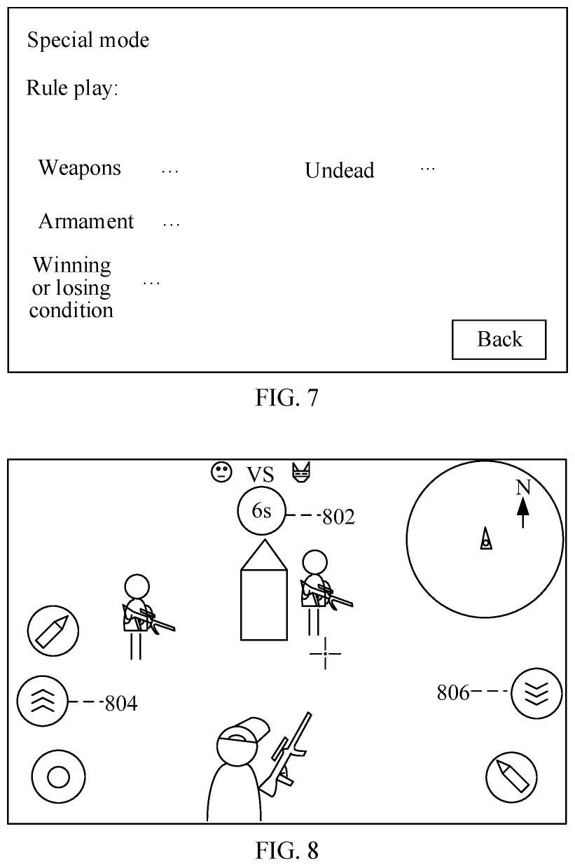

In this embodiment of this application, a special mode may be separately set for the game. The special mode is different from existing fighting. A camp of each virtual role is initially fixed, and the camp may be changed after all virtual roles are allocated as virtual roles of the first camp and virtual roles of the second camp. After the two camps are in opposition, the virtual roles of the two camps compete with or attack each other. The virtual roles in the first camp and the second camp may attack each other. For example, FIG. 6 is an exemplary mode selection interface displayed on a client. A user may select the foregoing special mode by using the interface, and determine the special mode by using an OK key. A button 602 may further be displayed on the display interface, and detailed information of the special model may be displayed by tapping the button, or the specific model jumps to a details page after the button is tapped. FIG. 7 is the details page of the special mode. In this page, the user can view detailed information such as play methods. The user can return to the previous page through a back key.

After the user selects the special mode and enters the game, the virtual scene of the virtual game may be displayed on a display interface of a first client used by the user. The virtual scene includes a first virtual role of the user and another virtual role controlled by another user. When the virtual game starts, some virtual roles belong to the first camp, and some virtual roles belong to the second camp. The user may select the initial camp, or randomly allocate the initial camp. Alternatively, all virtual roles belong to the first camp, and after the game starts, camps of a part of virtual roles are adjusted to the second camp, so that virtual roles of the first camp fight against virtual roles of the second camp.

If the initial camps of all the virtual roles are the first camp, clients of all the virtual roles may display prompt information, which may be countdown, prompt voice, or prompt text. It is prompted that in the virtual scene, a virtual role will change from the first camp to the second camp, the second camp may be a zombie camp, and the first camp may be a human camp. As shown in FIG. 8, countdown 802 is displayed. It is prompted that after the countdown ends, a human virtual role of the first camp will change to an undead of the second camp in the virtual scene. Human virtual roles are hostile to the undead and can attack each other. In another example, in this application, two functions may be further provided to the user, for example, a button 804 and a button 806 in FIG. 8. The user may tap the button 804 to improve a possibility of turning into an undead after the countdown ends, or tap the button 804 to apply for turning into an undead after the countdown ends, or tap the button 806 to reduce a possibility of turning into an undead after the countdown ends, or tap the button 806 to reject turning into an undead after the countdown ends.

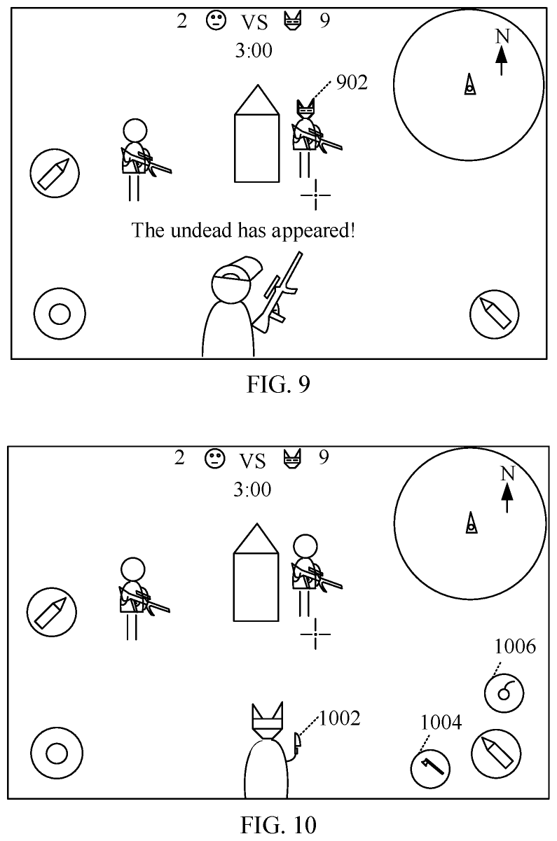

After the countdown ends, a random virtual role in the virtual scene is selected as an undead, and is changed to an undead. For example, as shown in FIG. 9, an object 902 is initially a human virtual role, and becomes an undead after the countdown ends.

By using this example, in a process of performing the virtual game, a camp of a virtual role in the scene may be adjusted in the virtual scene, thereby implementing an effect of improving change efficiency of the camp of the virtual role.

Certainly, if the virtual role of the first camp and the virtual role of the second camp are initially included, countdown may be displayed. In a countdown process, attacks between the virtual role of the first camp and the virtual role of the second camp are invalid, and after the countdown ends, the virtual roles of the two camps can effectively attack each other. In another example, in this embodiment of this application, in a process of changing a human role to an undead, a prompt may be performed in a manner such as a voice prompt or a text prompt on the display interface, to prompt that a role is changed to an undead. Alternatively, in the foregoing method, that a role is changed to an undead is prompted by changing a display model of the role. The display model is appearance of the role in the virtual scene, and the client can display the model in the virtual scene. By using this method, it can be clearly observed which role changes to an undead, thereby improving prompt efficiency.

In another example, in this embodiment of this application, when a human role changes to an undead, a display model changes, but a weapon does not change. For example, a human role holds a gun. After the countdown ends, the human role changes to an undead, the undead still holds the gun and attacks a remaining human role by using the gun, and the human role attacks the undead by using a gun. By using this method, a remote fight method may be provided for the undead, so as to avoid that a fight capability of the undead is too low and is easily defeated by the human role, thereby improving fairness of the game.

In another example, in this embodiment of this application, after the undead kills the first human role, a prop of the undead may be changed to a more powerful prop, for example, more powerful close-in weapons like a baseball stick and a dagger, and a second prop may be configured for the undead, for example, the second prop further includes signal smoke and a throwing axe. The throwing axe may be thrown to attack a human role in the virtual scene, and the undead may throw the signal smoke to any first location that can be thrown at in the virtual scene. When the undead is killed by the human role, the undead may resurrect at the location of the signal smoke. For example, FIG. 10 is a display interface of a client of a role of an undead, and a prop of the undead is changed to a close-in weapon 1002, a throwing axe 1004, and signal smoke 1006.

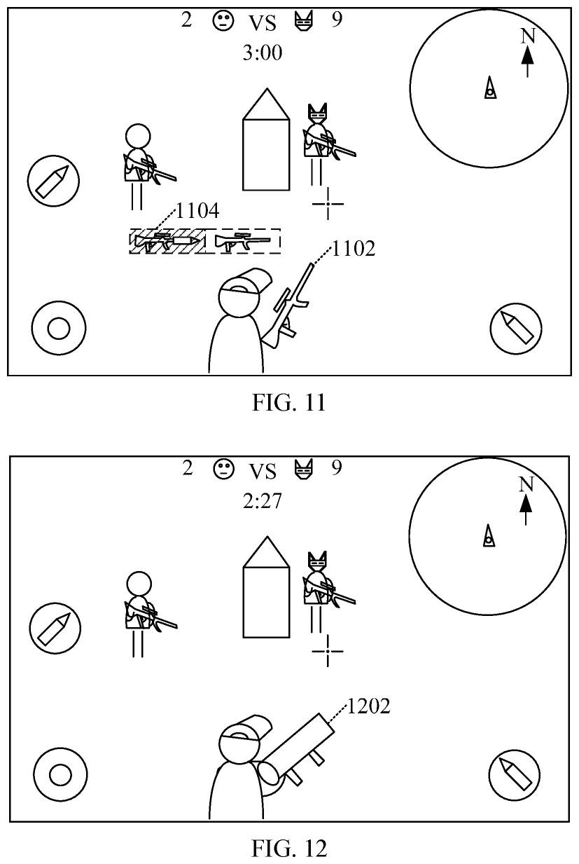

In another example, in this embodiment of this application, when a human role uses a weapon to attack an undead, a corresponding score may be increased, and the score may be increased when the undead is hit or killed. If the score is high enough or the undead is killed, a more powerful weapon can be provided for the human role. For example, as shown in FIG. 11, a weapon 1102 of a human role in FIG. 11 is an initial weapon, and 1104 is a more powerful weapon. The weapon 1104 is temporarily un-selectable, and cannot be activated until the human kills an undead. The weapon 1104 can be selected after being activated. The user may use the activated weapon 1104 by tapping.

In another example, if a quantity of undead killed by the human role is greater than a first threshold, or a quantity of remaining human roles is less than a second threshold, the remaining human role may be changed to a fearless fighter, and a more powerful weapon is configured. The fearless fighter may have a higher hit point, and after being killed by the undead, the fearless fighter does not change to an undead, but dies in the virtual scene. When the fearless fighter kills the undead, the undead will not resurrect. For example, FIG. 12 shows that a human role is changed to an undead and has a more powerful weapon 1202.

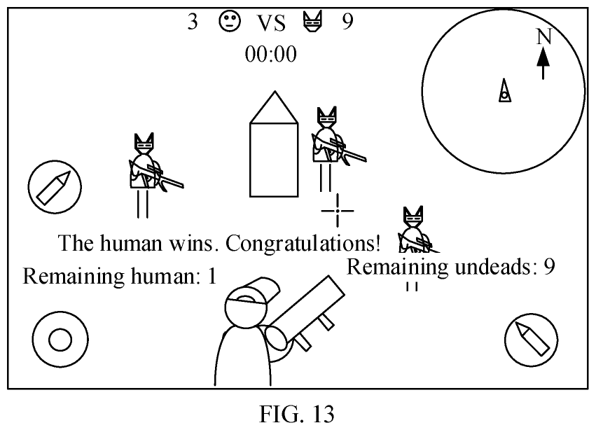

In an example, after the virtual game is performed for a period of time, for example, three minutes, if there is a human role in the virtual scene, the human role wins, prompt information indicating that the human wins is displayed on clients of all players associated with the human roles, and prompt information indicating that the undead loses is displayed on clients of all players associated with the undeads. If all humans are infected as undeads within three minutes, prompt information indicating that the undead wins is displayed on the clients of all players associated with the undeads. For example, FIG. 13 shows a case in which a remaining human role exists after three minutes, which indicates that the human role wins. In some other embodiments, the virtual game ends at the moment when there is only one remaining human roles in the virtual game while all the other human roles have been infected to be undeads.

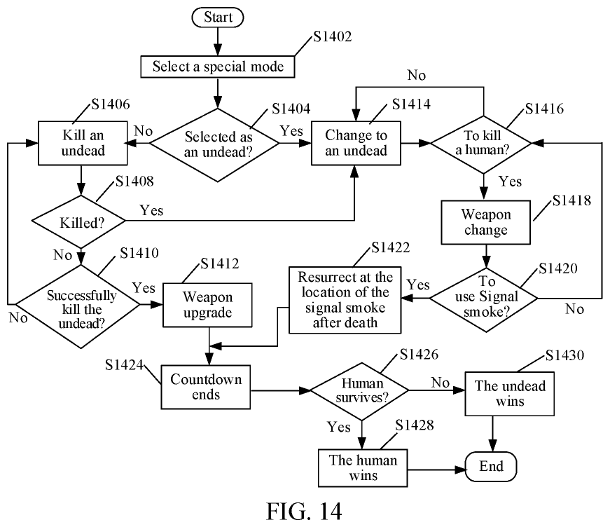

A flowchart of a virtual role control method provided in this embodiment of this application may be shown in step S1402 to step S1430 in FIG. 14. First, S1402, select a mode, and select a special mode. In the special mode, S1404, determine whether the undead is selected. If the undead is not selected, S1406, kill the undead. S1408, determine whether it is killed. If not, S1410, determine whether the undead is successfully killed. If the undead is killed successfully, S1412, upgrade the weapon. If the undead is not killed successfully, S1406, kill the undead. If it is killed in S1408 or is selected as the undead in S1404, S1414, become an undead, and then S1416, determine whether to kill a human. If it is to kill a human, S1418, the weapon changes, and S1420, determine whether to use signal smoke. If the signal smoke is used, S1422, resurrect at the location of the signal smoke after death, and S1424, countdown ends. At the end of the countdown, S1426, determine whether there is human survival. If there is human survival, S1428, the human wins; or if there is no human survival, S1430, the undead wins. In this process, if it is not to kill a human in S1416, S1414, continue to be an undead. If the signal smoke is not used in S1420, perform S1416.

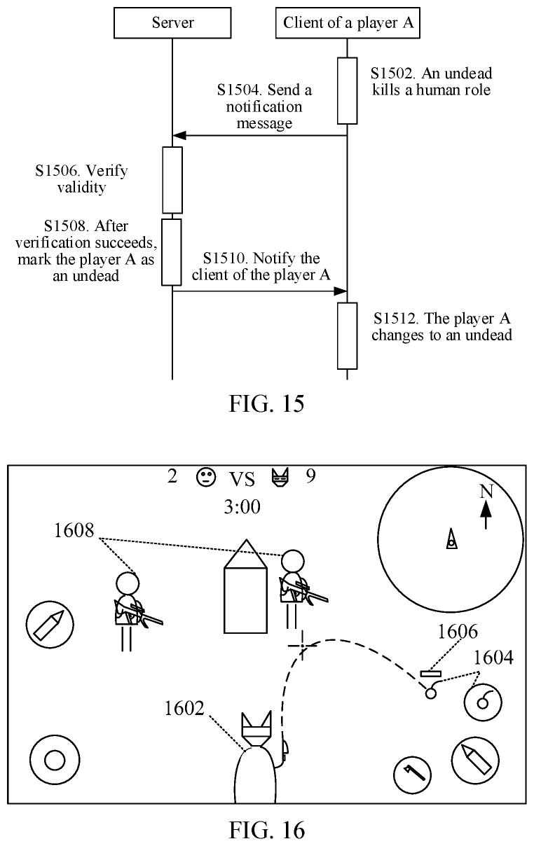

In this embodiment of this application, a role in the virtual scene is randomly selected as an undead. A human player is randomly selected as an undead. The undead kills the human, and the human kills the undead. As shown in FIGS. 15, S1502 to S1512 are a flowchart of changing a human role to an undead. When a player A logs in to a client to control a human role, S1502, the human role of the player A is killed, S1504, the client sends a notification message to a server, S1506, the server verifies validity of the kill, if it is valid, S1508, mark the player A as an undead, and S1510, and deliver the state of the player A. The client of the player A performs S1512, change the human role of the player A to an undead.

In some embodiments, in the foregoing game process, the virtual role undead of the second camp may resurrect at the first location of the signal smoke after the undead throws the signal smoke. Certainly, as a virtual role of the first camp, a human can destroy the signal smoke. The human can destroy the signal smoke by removing or destroying the signal smoke. Removing the signal smoke may be performing a corresponding action by the human near the signal smoke. Destroying the signal smoke may be attacking the signal smoke by the human by using a prop. The signal smoke may be set with a hit point, which is destroyed when the hit point is zeroed. For example, FIG. 16 is an exemplary display interface of signal smoke with a hit point. An undead 1602 throws signal smoke 1604 into a virtual scene. The signal smoke 1604 includes a lifebar 1606, and a human 1608 may attack the signal smoke. If the lifebar of the signal smoke is zeroed, the signal smoke is destroyed. After the signal smoke is destroyed, the undead cannot resurrect at the location of the signal smoke after death, but resurrects at a random location in the virtual scene.

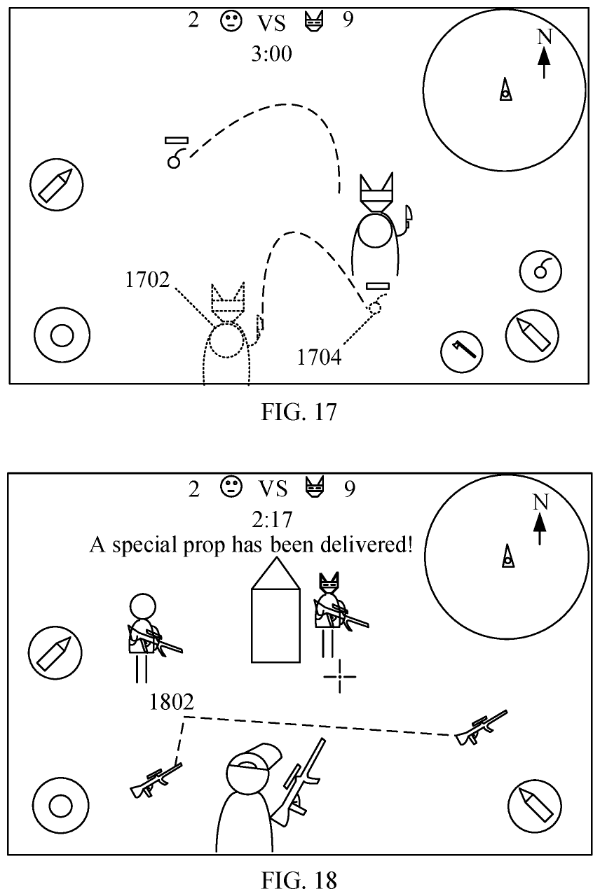

The undead may re-throw the signal smoke to a second location after picking up the signal smoke. If the undead died, the undead may resurrect at the second location. As shown in FIG. 17, an undead 1702 first throws signal smoke 1704 to a first location in a virtual scene, then moves to the first location, picks up the signal smoke, and then throws the signal smoke to a second location in the virtual scene. After the undead died, the undead will resurrect at the second location in the virtual scene.

A human may pick up a first prop in the virtual scene. For example, as shown in FIG. 18, a first prop 1802 is randomly placed in a virtual scene, and it is prompted that a special prop is delivered, so as to remind a virtual role of a first camp to contend for it. The undead cannot pick up the first prop.

The human can obtain the first prop by killing the undead. If a quantity of killed undeads reaches a first threshold, the first prop is configured for the human. The human may switch to and use the first prop.

After a human role is killed by an undead, a model of the human role is replaced with a model of the undead when the human role resurrects. When the undead throws signal smoke, the location of the signal smoke is recorded, and the undead will resurrect at the location of the signal smoke. In this application, when a weapon of the undead is a remote weapon, a bullet may be fired to attack the human role. The bullet is radiated from a muzzle as a ray. When the ray collides with another object, the bullet is detected to hit another weapon. If the weapon of the undead is a close-in weapon, such as a knife or a baseball stick, a collision box is used for detection. When a collision frame of the close-in weapon detects a collision with another object in a moving process, it is considered that the knife attacks the another object. The size and length of the collision frame are configured. If the collision frame attacks a human role, it is considered that the knife attacks the human, and the human role dies and changes to an undead after resurrection.

For ease of description, the foregoing method embodiments are stated as a combination of a series of actions. However, a person skilled in the art is to know that this embodiment of this application is not limited to the described action sequence, because according to this embodiment of this application, some steps may be performed in another sequence or simultaneously. In addition, a person skilled in the art also appreciates that all the embodiments described in this specification are preferred embodiments, and the related actions and modules are not necessarily mandatory to the embodiments of the present disclosure.

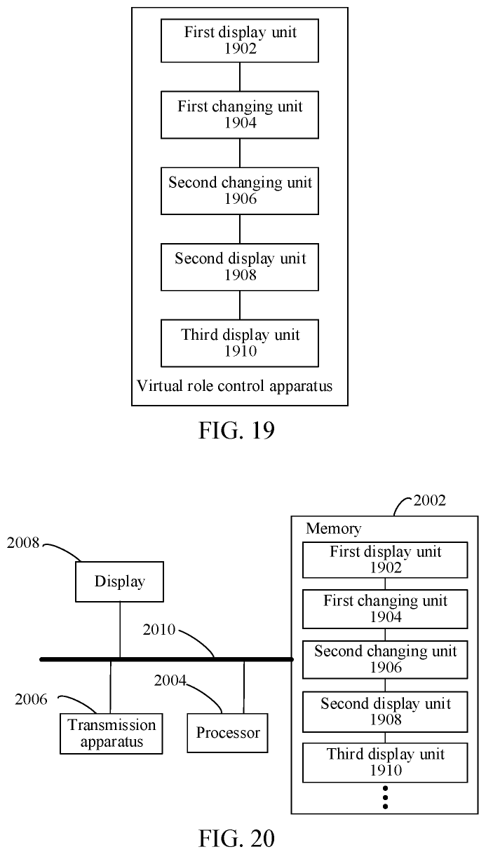

An embodiment of this application further provides a virtual role control apparatus used for implementing the foregoing virtual role control method. As shown in FIG. 19, the apparatus includes:

a first display unit 1902, configured to: when a virtual task is entered, display, on a display interface of a first client, a virtual scene corresponding to a virtual task, the virtual scene including a virtual role belonging to a first camp and a virtual role belonging to a second camp, and the second camp being an opposite camp of the first camp;

a first changing unit 1904, configured to: change, when a first target virtual role in the first camp is killed by the virtual role of the second camp, a camp to which the first target virtual role belongs from the first camp to the second camp;

a second changing unit 1906, configured to: change, when a second target virtual role in the second camp is killed by the virtual role of the first camp by using a first prop, a camp to which the second target virtual role belongs from the second camp to the first camp;

a second display unit 1908, configured to display, on the display interface when all virtual roles of the first camp are killed in the virtual scene, that the virtual role of the second camp wins; and

a third display unit 1910, configured to display, on the display interface when duration for executing the virtual task reaches predetermined duration and at least one virtual role of the first camp still exists in the virtual scene, that the virtual role of the first camp wins.

In some embodiments, the foregoing virtual role control apparatus may be applied to the game field but is not limited thereto. A game may be but is not limited to a single-player game or a multi-player game. The single-player game may include a plurality of virtual roles, and all other roles except a first virtual role controlled by a first client are computer-controlled virtual roles. If the game is a multi-player game, each client of a plurality of clients may separately control one virtual role, and play the game in one virtual scene by using a server. The plurality of clients may display content in the virtual scene by using a display interface.

The virtual scene in this embodiment of this application may be a virtual scene of a virtual game constructed by the client or the server. The virtual scene may include a plurality of virtual roles. The first client displays the virtual scene by using the display interface, and the plurality of roles in the virtual scene may belong to different camps. For example, the virtual role belonging to the first camp and the virtual role belonging to the second camp are included. The virtual role of the first camp and the virtual role of the second camp are mutually hostile roles, and when the first target virtual role in the first camp is killed by the virtual role of the second camp, the camp to which the first target virtual role belongs is changed from the first camp to the second camp; and when the second target virtual role in the second camp is killed by the virtual role of the first camp by using the first prop, the camp to which the second target virtual role belongs is changed from the second camp to the first camp.

In this embodiment of this application, in the process of executing the virtual task in the virtual scene, the camp of the virtual role can be automatically adjusted according to interaction between virtual roles in different camps, and the current virtual task does not need to end to re-enter the virtual scene to adjust the camp of the virtual role, thereby improving adjustment efficiency of the camp to which the virtual role belongs in the virtual scene, and improving human-computer interaction efficiency while improving utilization of a hardware resource.

In some embodiments, in this embodiment of this application, when the virtual scene is created, a plurality of roles in the virtual scene may be divided into virtual roles of the first camp and virtual roles of the second camp.

Alternatively, when the virtual scene is created, all roles in the virtual scene are virtual roles of the first camp, and within a period of time after the virtual scene is created, one or more roles in the camp are determined as virtual roles of the second camp.

In some embodiments, in this embodiment of this application, when the camp of the virtual role is changed, a display model of the virtual role may also be changed. Changes to the display model allow to intuitively see changes in the camp of the virtual role. In addition, in this embodiment of this application, a prompt may be performed on the display interface of the client, or a prompt may be performed via voice, so as to prompt a change to the camp of the virtual role.

In some embodiments, in this embodiment of this application, a third prop may be configured for the virtual role of the first camp, and the third prop may be a weapon, an armament, a consumable, or the like that can be used. The third prop may be a prop configured by the user before the virtual role of the first camp enters the virtual scene of the virtual game, or a prop allocated by the virtual scene after the virtual scene of the virtual game is entered. The virtual role of the first camp may attack the virtual role of the second camp by using the third prop. The virtual role of the second camp may be initially configured with a fourth prop to attack the virtual role of the first camp. Alternatively, the virtual role of the second camp may be configured with a third prop that is the same as that of the virtual role of the first camp. The virtual role of the second camp may attack the virtual role of the first camp by using the third prop/the fourth prop.

In this embodiment of this application, the virtual role of the first camp may pick up the first prop in the virtual scene, or configure the first prop for the virtual role of the first camp if a condition is met. After killing the virtual role of the second camp, the first prop may change the camp of the virtual role of the second camp to the first camp. The first prop may be placed in the virtual scene when a running time of the virtual task meets a requirement. If the virtual role of the first camp picks up the first prop, the first prop may be configured in a backpack of the virtual role of the first camp. The virtual role of the first camp may switch to and use the first prop. Alternatively, if a quantity of virtual roles in the second camp killed by the virtual role of the first camp reaches a first threshold, the first prop is configured into the backpack for the virtual role of the first camp.

In this embodiment of this application, when the virtual role of the second camp attacks the virtual role of the first camp by using the fourth prop, a hit point value of the virtual role of the first camp decreases. If the hit point value of the virtual role of the first camp is zeroed, the camp of the virtual role of the first camp whose hit point value is zeroed is changed to the second camp. In this case, a prop of the virtual role of the second camp may be upgraded, and a second prop may be configured for the virtual role of the second camp. The virtual role of the second camp may set a resurrection location by using the second prop. In addition, a more powerful attack prop may be configured for the virtual role of the second camp. If the virtual role of the second camp attacks the virtual role of the first camp by using the attack prop, the camp of the virtual role of the first camp that is hit is adjusted to the second camp as long as it is hit.

That is, the virtual role of the second camp in this embodiment of this application may upgrade the weapon by attacking or killing the virtual role of the first camp, and attack power of the weapon may be increasingly strong. In this embodiment of this application, the virtual role of the second camp may further evolve by killing the virtual role of the first camp, so as to acquire a higher hit point, a faster moving speed, an increased skill, and the like.

The second prop of the virtual role of the second camp may be thrown or placed in the virtual scene. After the second prop is thrown, a first location of the second prop is recorded. If a first hit point of the virtual role of the second camp reaches zero, the virtual role may be resurrected, and the resurrection location is in the first location.

Certainly, after being thrown or placed in the virtual scene, the second prop may be removed or attacked by the virtual role of the first camp. If the virtual role of the first camp removes the second prop placed by the virtual role of the second camp at the first location in the virtual scene, or attacks the second prop and destroys the second prop, the virtual role of the second camp that throws the second prop is resurrected at a random location in the virtual scene after the first hit point is zeroed, and cannot be resurrected at the first location.

In addition, after the second prop of the virtual role of the second camp is thrown to the first location, if the virtual role of the second camp picks up the second prop and throws it to a second location in the virtual scene, the virtual role of the second camp is resurrected at the second location after the first hit point is zeroed.

The virtual role of the first camp in this embodiment of this application may activate a more powerful weapon or improve a capability by killing the virtual role of the second camp, for example, increase an attack force.

A plurality of prop selections may be added to the virtual roles of the first camp. The props are initially in an un-selectable first state. After the virtual role of the first camp kills the virtual role of the second camp, powerful props may be gradually unlocked according to the quantity of killed virtual roles of the second camp, and the powerful props are adjusted from the first state to a second state. The powerful props that are adjusted to the second state may be selected and used by the virtual role of the first camp. The powerful props may have a stronger attack force or a faster shooting speed or a larger magazine size or higher accuracy.

In this embodiment of this application, if the quantity of virtual roles of the second camp killed by the virtual role of the first camp reaches a third threshold, or a quantity of remaining virtual roles of the first camp is less than a fourth threshold, a prop of the virtual role of the first camp may be changed from a current prop to a more powerful prop.

In this embodiment of this application, if the virtual task runs for a period of time, and the first camp still includes a virtual role that is not changed to the second camp, a level of the prop of the virtual role of the first camp is upgraded. The higher the level, the stronger the attribute may be, for example, the faster the shooting speed, the more the bullet capacity, the higher the power.

In another example, when the quantity of virtual roles of the second camp killed by the virtual role of the first camp reaches a third threshold, or a quantity of remaining virtual roles of the first camp is less than a fourth threshold, the virtual role of the first camp may be changed to a fighter virtual role with a stronger attribute. For example, the fighter virtual role is no longer attacked or does not change its camp after being killed, and the virtual role of the second camp that is killed by the fighter virtual role will not be resurrected. The fighter virtual role may have a hit point. When the virtual role of the second camp attacks the fighter virtual role, the hit point of the fighter virtual role decreases. If the hit point of the fighter virtual role falls to zero, the fighter virtual role dies, does not change to the virtual role of the second camp, and does not resurrect.

In this embodiment of this application, in a process in which the virtual role of the first camp and the virtual role of the second camp attack each other or compete with each other, a winning or losing condition may be set. For example, the winning or losing condition may be the quantity of kills. If a total quantity of virtual roles killed by a virtual role of a camp is higher, the virtual role of the camp wins. Alternatively, in the virtual scene of the virtual game, all virtual roles change to virtual roles of the second camp, or duration of the virtual game may be used as a winning or losing condition. For example, if the game is performed for three minutes, and all the virtual roles in the three minutes become virtual roles of the second camp, the virtual roles of the second camp win. If there is still the virtual role of the first camp when three minutes ends, the remaining virtual role of the first camp wins, and the virtual role of the second camp loses.

In this embodiment of this application, the virtual role of the second camp may be changed to the virtual role of the first camp by using a predetermined prop. After the virtual role of the second camp is changed to the virtual role of the first camp, the prop is restored to the first prop. The predetermined prop may be a prop randomly generated in the virtual scene, and may be delivered at an interval of predetermined duration.

In this embodiment of this application, after the virtual role of the second camp attacks the virtual role of the first camp or kills the virtual role of the first camp, the virtual role of the first camp is changed to the virtual role of the second camp, and the camp of the virtual role of the second camp is changed to the first camp, thereby ensuring a virtual role balance of the two camps.

In some embodiments, after the virtual role of the first camp uses the first prop to kill the virtual role of the second camp, and when the camp of the virtual role of the second camp is changed to the first camp, determining may be further performed: If an initial camp of a killed virtual role is the first camp, and the camp of the virtual role is changed to the second camp after the virtual role is killed, the camp of the virtual role of the second camp may be re-adjusted to the first camp. If the initial camp of the virtual role of the second camp is the second camp, the camp of the virtual role of the second camp is no longer adjusted to the first camp.

According to this embodiment, by using the foregoing method, in a process of performing the virtual game, a camp of a virtual role in the scene may be adjusted in the virtual scene, thereby implementing an effect of improving change efficiency of the camp of the virtual role.

For another instance of this embodiment, refer to the foregoing embodiment. Details are not described herein again.

An embodiment of this application further provides a computer device used for implementing the foregoing virtual role control method. As shown in FIG. 20, the computer device includes a memory 2002 and a processor 2004. The memory 2002 stores a computer program, and the processor 2004 is configured to perform, by using the computer program, the virtual role control method provided in the embodiment of this application.

In some embodiments, the computer device may be located in at least one of a plurality of network devices in a computer network.

In some embodiments, the processor may be configured to perform the following steps by using a computer program:

when a virtual task is entered, displaying, on a display interface of a first client, a virtual scene corresponding to a virtual task, the virtual scene including a virtual role belonging to a first camp and a virtual role belonging to a second camp, and the second camp being an opposite camp of the first camp;

changing, when a first target virtual role in the first camp is killed by the virtual role of the second camp, a camp to which the first target virtual role belongs from the first camp to the second camp;

changing, when a second target virtual role in the second camp is killed by the virtual role of the first camp by using a first prop, a camp to which the second target virtual role belongs from the second camp to the first camp;

displaying, on the display interface when all virtual roles of the first camp are killed in the virtual scene, that the virtual role of the second camp wins; and

displaying, on the display interface when duration for executing the virtual task reaches predetermined duration and at least one virtual role of the first camp still exists in the virtual scene, that the virtual role of the first camp wins.

In some embodiments, a person of ordinary skill in the art may understand that the structure shown in FIG. 20 is merely an example, and the computer device may be a terminal device such as a smartphone (for example, an Android mobile phone and an iOS mobile phone), a tablet computer, a palmtop computer, a mobile Internet device (MID), and a PAD. FIG. 20 does not constitute a limitation on a structure of the computer device. For example, the computer device may further include more or fewer components (such as a network interface) than those shown in FIG. 20, or have a configuration different from that shown in FIG. 20.

The memory 2002 may be configured to store a software program and a module, for example, a program instruction/module corresponding to the virtual role control method and apparatus in the embodiments of this application. The processor 2004 executes various functional applications and data processing by running the software program and the module that are stored in the memory 2002, that is, implements the virtual role control method. The memory 2002 may include a high-speed random access memory, and may further include a non-volatile memory, for example, at least one disk storage device, a flash memory, or other non-volatile solid-state memories. In some embodiments, the memory 2002 may further include memories disposed remotely from the processor 2004. The remote memories may be connected to the terminal by a network. The foregoing examples of the network include, but are not limited to, the Internet, an intranet, a local area network, a mobile communication network, and a combination thereof. The memory 2002 may be specifically configured to store information such as a role of the first camp and a role of the second camp and a state of each role. As an example, as shown in FIG. 20, the memory 2002 may be but is not limited to including the first display unit 1902, the first changing unit 1904, the second changing unit 1906, the second display unit 1908, and the third display unit 1910 in the foregoing virtual role control apparatus. In addition, the virtual role control apparatus may further include but is not limited to another module unit in the foregoing virtual role control apparatus. Details are not described in this example.

In some embodiments, the above transmission apparatus 2006 is configured to receive or transmit data through a network. Specific examples of the network may include a wired network and a radio network. In an example, the transmission apparatus 2006 includes a network interface controller (NIC). The NIC may be connected to another network device and a router by using a network cable, to communicate with the Internet or a local area network. In an example, the transmission apparatus 2006 is a radio frequency (RF) module that is configured to communicate with the Internet in a wireless manner.

In addition, the foregoing computer device further includes a display 2008 configured to display a virtual scene; and a connection bus 2010, configured to connect each module component in the foregoing computer device.

An embodiment of this application further provides a computer readable storage medium, where the storage medium stores a computer program, and the computer program is configured to run to perform the virtual role control method provided in the embodiment of this application.

In some embodiments, the storage medium may be configured to store a computer program configured to perform the following steps.

when a virtual task is entered, displaying, on a display interface of a first client, a virtual scene corresponding to a virtual task, the virtual scene including a virtual role belonging to a first camp and a virtual role belonging to a second camp, and the second camp being an opposite camp of the first camp;

changing, when a first target virtual role in the first camp is killed by the virtual role of the second camp, a camp to which the first target virtual role belongs from the first camp to the second camp;

changing, when a second target virtual role in the second camp is killed by the virtual role of the first camp by using a first prop, a camp to which the second target virtual role belongs from the second camp to the first camp;

displaying, on the display interface when all virtual roles of the first camp are killed in the virtual scene, that the virtual role of the second camp wins; and

displaying, on the display interface when duration for executing the virtual task reaches predetermined duration and at least one virtual role of the first camp still exists in the virtual scene, that the virtual role of the first camp wins.

In some embodiments, a person of ordinary skill in the art may understand that all or some of the steps of the methods in the foregoing embodiments may be implemented by a program instructing relevant hardware of the terminal device. The program may be stored in a computer-readable storage medium. The storage medium may include a flash disk, a read-only memory (ROM), a random access memory (RAM), a magnetic disk, an optical disk, and the like.

The sequence numbers of the foregoing embodiments of this application are merely for description purpose, and are not intended to indicate the preference among the embodiments.

When the integrated unit in the foregoing embodiments is implemented in the form of a software function unit and sold or used as an independent product, the integrated unit may be stored in the foregoing computer-readable storage medium. Based on such an understanding, the technical solutions of the present disclosure essentially, or the part contributing to the related technology, or all or some of the technical solutions may be represented in a form of a software product. The computer software product is stored in a storage medium and includes several instructions for instructing one or more computer devices (which may be a personal computer, a server, or a network device) to perform all or some of the steps of the methods in the embodiments of the present disclosure.

In the foregoing embodiments of this application, the description about each embodiment emphasizes a different facet. For a part that is not detailed in one embodiment, reference may be made to the relevant description in other embodiments.

In the several embodiments provided in this application, it is to be understood that the disclosed client may be implemented in other manners. The apparatus embodiments described above are merely exemplary. For example, the division of the units is merely the division of logic functions, and may use other division manners during actual implementation. For example, a plurality of units or components may be combined, or may be integrated into another system, or some features may be omitted or not performed. In addition, the displayed or discussed couplings between different parts or direct couplings or communication connections may be indirect couplings or communication connections implemented through some interfaces, units, or modules, and may be implemented electrically or in other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments hereof.

In addition, functional units in the embodiments of this application may be integrated into one processing unit, or each of the units may exist alone physically, or two or more units may be integrated into one unit. The integrated unit may be implemented in a form of hardware, or may be implemented in a form of a software functional unit.

The above descriptions are merely preferred embodiments of this application, and a person of ordinary skill in the art may make various improvements and modifications without departing from the principle of this application. All such improvements and modifications shall also fall within the protection scope of this application. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A virtual role control method performed by a computer device, the method comprising:
displaying, on a display interface, a virtual scene corresponding to a virtual task, the virtual scene comprising at least one virtual role belonging to a first camp and at least one virtual role belonging to a second camp;
when a first target virtual role in the first camp is killed by a virtual role of the second camp, switching the first target virtual role from the first camp to the second camp;
when all the virtual roles of the first camp are killed in the virtual scene, displaying that the second camp wins on the display interface; and
when a duration for executing the virtual task reaches a predetermined duration and at least one virtual role of the first camp still exists in the virtual scene, displaying that the first camp wins on the display interface.

2. The method according to claim 1, wherein the virtual role of the first camp and the virtual role of the second camp have different visual appearances.

3. The method according to claim 1, wherein the method further comprises:
when a virtual role of the second camp is killed by a virtual role of the first camp, respawning the virtual role of the second camp at a first location of the virtual scene.

4. The method according to claim 3, wherein the first location is a location randomly selected before the virtual role of the second camp is respawned.

5. The method according to claim 3, wherein the method further comprises:
when the virtual role of the second camp marks a second location, determining the second location as the first location associated with the virtual role of the second camp.

6. The method according to claim 5, wherein the method further comprises:
when the virtual role of the second camp marks a third location, changing the first location associated with the second target virtual role from the second location to the third location.

7. The method according to claim 5, wherein the method further comprises:
when a virtual role of the first camp de-marks a first location, setting the first location associated with the second target virtual role to a location to be randomly selected.

8. The method according to claim 1, wherein the method further comprises:
when a second target virtual role in the second camp is affected by a virtual role of the first camp by using a first prop, switching a camp to which the second target virtual role belongs from the second camp to the first camp.

9. The method according to claim 8, wherein the first prop is provided in the virtual scene for pick up.

10. The method according to claim 8, wherein the first prop is provided to a virtual role of the first camp when a quantity of virtual roles in the second camp killed by the virtual role of the first camp is greater than a first threshold.

11. The method according to claim 1, wherein the method further comprises:
when combat information associated with a virtual role of the first camp meets a predetermined condition, strengthening the virtual roles of the first camp's combat ability.

12. The method according to claim 11, wherein strengthening the virtual roles of the first camp's combat ability comprises:
when the quantity of virtual roles in the second camp killed by the virtual role of the first camp reaches a second threshold:
providing new equipment or skill to the virtual roles of the first camp,
upgrading equipment or skill of the virtual roles of the first camp, or
increasing combat parameter of the virtual roles of the first camp.

13. The method according to claim 11, wherein strengthening the virtual roles of the first camp's combat ability comprises:
when a virtual role of the first camp is the only one virtual role of the first camp:
providing new equipment or skill to the virtual roles of the first camp,
upgrading equipment or skill of the virtual roles of the first camp, or
increasing combat parameter of the virtual roles of the first camp.

14. A computer device, comprising a memory and a processor;
the memory being configured to store executable instructions; and
the processor being configured to: when running the executable instructions stored in the memory, implement a virtual role control method including:
displaying, on a display interface, a virtual scene corresponding to a virtual task, the virtual scene comprising at least one virtual role belonging to a first camp and at least one virtual role belonging to a second camp;
when a first target virtual role in the first camp is killed by a virtual role of the second camp, switching the first target virtual role from the first camp to the second camp;
when all the virtual roles of the first camp are killed in the virtual scene, displaying that the second camp wins on the display interface; and
when a duration for executing the virtual task reaches a predetermined duration and at least one virtual role of the first camp still exists in the virtual scene, displaying that the first camp wins on the display interface.

15. The computer device according to claim 14, wherein the virtual role of the first camp and the virtual role of the second camp have different visual appearances.

16. The computer device according to claim 14, wherein the method further comprises:
when a virtual role of the second camp is killed by a virtual role of the first camp, respawning the virtual role of the second camp at a first location of the virtual scene.

17. The computer device according to claim 14, wherein the method further comprises:
when a second target virtual role in the second camp is affected by a virtual role of the first camp by using a first prop, switching a camp to which the second target virtual role belongs from the second camp to the first camp.

18. The computer device according to claim 14, wherein the method further comprises:
when combat information associated with a virtual role of the first camp meets a predetermined condition, strengthening the virtual roles of the first camp's combat ability.

19. A non-transitory computer readable storage medium that stores executable instructions that, when executed by a processor of a computer device, causes the computer device to implement a virtual role control method including:
displaying, on a display interface, a virtual scene corresponding to a virtual task, the virtual scene comprising at least one virtual role belonging to a first camp and at least one virtual role belonging to a second camp;
when a first target virtual role in the first camp is killed by a virtual role of the second camp, switching the first target virtual role from the first camp to the second camp;
when all the virtual roles of the first camp are killed in the virtual scene, displaying that the second camp wins on the display interface; and
when a duration for executing the virtual task reaches a predetermined duration and at least one virtual role of the first camp still exists in the virtual scene, displaying that the first camp wins on the display interface.

20. The non-transitory computer readable storage medium according to claim 19, wherein the method further comprises:
when combat information associated with a virtual role of the first camp meets a predetermined condition, strengthening the virtual roles of the first camp's combat ability.
